(19) United States
(12) Patent Application Publication
(10) Pub. No.: US 2025/0121597 A1
(43) Pub. Date: Apr. 17, 2025

(54) LIQUID DISCHARGE APPARATUS

(71) Applicant: CANON KABUSHIKI KAISHA, Tokyo (JP)

(72) Inventors: DAIGO KURONUMA, Kanagawa (JP); TOMOYUKI NAGASE, Kanagawa (JP); RYOSUKE ARAKI, Kanagawa (JP)

(21) Appl. No.: 18/913,794

(22) Filed: Oct. 11, 2024

(30) Foreign Application Priority Data
Oct. 17, 2023 (JP) 2023-179029

(51) Int. Cl. B41J 2/165

(52) U.S. Cl. CPC B41J 2/16508

(57) ABSTRACT

A liquid discharge apparatus includes a cap configured to cap a discharge port surface of a discharge head that discharges a liquid, an absorbent member provided in the cap so as to face the discharge port surface, a supply unit configured to supply the liquid to the absorbent member via a supply port provided in the cap, and a discharge unit configured to discharge the liquid absorbed in the absorbent member via an outlet port provided in the cap. The supply port is provided at a position higher than the outlet port. The supply port is provided at a position equal to or higher than a surface of the absorbent member in a thickness direction of the absorbent member.

### BACKGROUND OF THE INVENTION

### Field of the Invention

The present invention relates to a liquid discharge apparatus.

### Description of the Related Art

In a liquid discharge apparatus that discharges a liquid such as ink, there is known a technique for capping a discharge port surface with a cap in order to maintain or recover a discharge performance of a discharge head (for example, Japanese Patent Laid-Open No. 2021-109331). Also known is an apparatus provided with an absorbent member in the cap for absorbing the liquid (for example, Japanese Patent Laid-Open No. 2022-30421). In the apparatus having the absorbent member, for example, the liquid on the discharge port surface can be absorbed by the absorbent member, by bringing the absorbent member into contact with the liquid on the discharge port surface.

In an apparatus provided with the absorbent member, the absorbent member becomes dirty along with the use of it. By supplying a cleaning liquid to the absorbent member and discharging it, the absorbent member can be cleaned, however, it is not desirable to take time for cleaning the absorbent member in view of the operation efficiency of the apparatus.

### SUMMARY OF THE INVENTION

The present invention provides a technique relating to a cap.

According to an aspect of the present invention, there is provided a liquid discharge apparatus comprising: a cap configured to cap a discharge port surface of a discharge head that discharges a liquid; an absorbent member provided in the cap so as to face the discharge port surface; a supply unit configured to supply the liquid to the absorbent member via a supply port provided in the cap; and a discharge unit configured to discharge the liquid absorbed in the absorbent member via an outlet port provided in the cap, wherein the supply port is provided at a position higher than the outlet port, and the supply port is provided at a position equal to or higher than a surface of the absorbent member in a thickness direction of the absorbent member.

Further features of the present invention will become apparent from the following description of exemplary embodiments (with reference to the attached drawings).

### BRIEF DESCRIPTION OF THE DRAWINGS

FIG. 1A is a front view of a liquid discharge system;

FIG. 1B is an explanatory view illustrating an internal structure of a liquid discharge apparatus constituting the system in FIG. 1A;

FIG. 2A is an explanatory view of a carriage and a maintenance unit;

FIG. 2B is an explanatory view of discharge port surfaces of discharge heads;

FIG. 3 is a perspective view of a cap unit;

FIG. 4 is an exploded perspective view of the cap unit;

FIG. 5 is a cross-sectional view taken along the line A-A in FIG. 3;

FIG. 6 is a view illustrating a cleaning mode of an absorbent member;

FIGS. 7A and 7B are views each illustrating a cleaning mode of the absorbent member;

FIG. 8 is a block diagram of a control unit of the liquid discharge apparatus;

FIG. 9 is a flowchart illustrating a processing example performed by the control unit;

FIGS. 10A to 10D are explanatory views each illustrating an operation example of the maintenance unit;

FIGS. 11A to 11D are explanatory views each illustrating the operation example of the maintenance unit;

FIG. 12A is an explanatory view illustrating the operation example of the maintenance unit;

FIG. 12B is an explanatory view illustrating another example of the cap unit;

FIG. 13 is an explanatory view of a full-line type discharge head;

FIGS. 14A to 14C are explanatory views of the cap unit corresponding to the full-line type discharge head; and

FIGS. 15A and 15B are explanatory views each illustrating another example of the cap unit.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

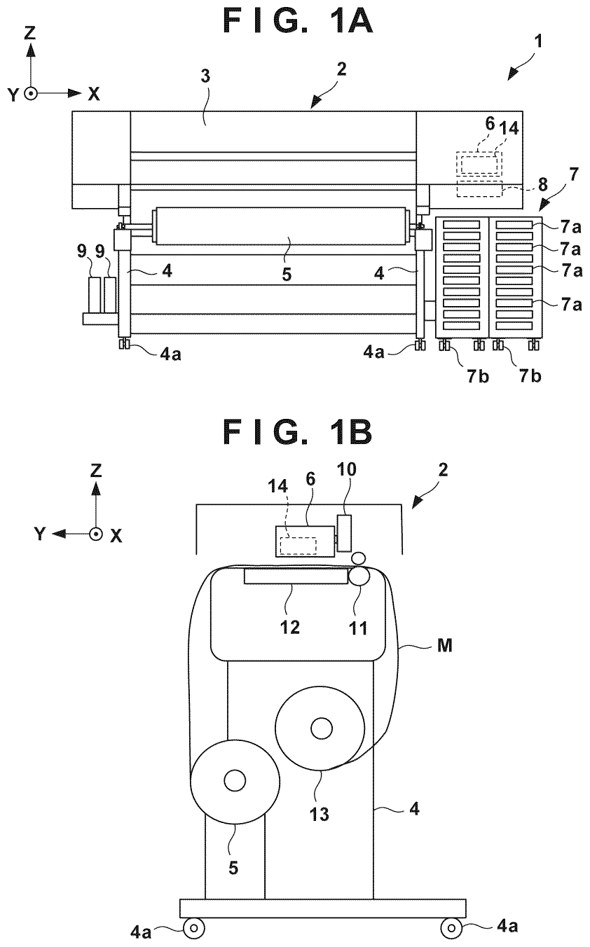

FIG. 1A is a front view of a liquid discharge system 1. In each figure, arrows X, Y and Z indicate directions that intersect each other and in this embodiment, that are orthogonal to each other. It is assumed that, when the system 1 is installed on a horizontal surface, the left-right direction is the X direction, the front-back direction is the Y direction and the up-down direction is the Z direction.

The liquid discharge system 1 of the present embodiment is a printing system, which includes a liquid discharge apparatus 2 and a liquid supply apparatus 7 according to one embodiment of the present invention, for printing images by discharging ink onto print medium such as paper. The liquid discharge apparatus 2 and the liquid supply apparatus 7 are arranged alongside of each other in the X direction. The liquid supplied by the liquid supply apparatus 7 to the liquid discharge apparatus 2 is the ink, and the liquid discharge apparatus 2 is a printing apparatus that discharges the ink onto print medium. However, the present invention is not limited to the printing apparatus and can be adopted to various liquid discharge apparatuses used for discharging the liquid onto media.

Note that “printing” includes not only a case of forming significant information such as characters graphics and the like but also a case of forming images, figures, patterns and the like on print media in a broad sense, or a case of processing print media, regardless of whether the information formed is significant or insignificant or whether the information formed is visualized so as to be perceived visually by a human. In addition, although in this embodiment, sheet-like paper is assumed as a “print medium”, cloth, a plastic film and the like may also be used.

### <Liquid Supply Apparatus>

The liquid supply apparatus 7 is an apparatus for supplying, to the liquid discharge apparatus 2, ink to be discharged from the discharge head 14 of the liquid discharge apparatus 2. Casters 7b are provided at the bottom surface of the liquid supply apparatus 7, whereby the liquid supply apparatus 7 can be moved on the floor relatively easily. The liquid supply apparatus 7 includes a plurality of housing portions 7a in which containers for containing inks are housed. Each of the containers is connected to the liquid discharge apparatus 2 via a tube, and the ink in each of the containers is supplied to the discharge head 14 via the tube.

The liquid supply apparatus 7 is located adjacent to the stand 4 and below an end portion on one side (a part where the maintenance unit 8 is built in) of the liquid discharge apparatus 2 in the X direction. The liquid discharge system 1 thus can be small-sized. The liquid supply apparatus 7 can be moved to a position where it contacts with the stand 4 in the X direction.

### <Liquid Discharge Apparatus>

An explanation will be given as to the liquid discharge apparatus 2 with reference to FIG. 1B in addition to FIG. 1A. FIG. 1B is an explanatory view illustrating the internal structure of the liquid discharge apparatus 2. The liquid discharge apparatus 2 is provided with a pair of left and right stands 4 and a main body 3 supported on the pair of stands 4. Each stand 4 has a caster 4a, with which the liquid discharge apparatus 2 can relatively easy move on the floor. A feeding unit 13 and a take-up unit 5 are arranged below the main body 3. In the case of this embodiment, the printing medium M is roll paper, and the feeding unit 13 has a shaft on which the printing medium Mis wound. The take-up unit 5 has a shaft for taking up the printing medium M. In the case of this embodiment, the roll paper is exemplified as the printing medium M, but cut paper may also be used.

The main body 3 is provided with a convey unit 11. The convey unit 11 has a driving roller and a driven roller extended in the X direction, and the printing medium M fed from the feeding unit 13 is sandwiched between nip portions of these rollers. The printing medium M is conveyed onto a platen 12 in the Y direction by the rotation of the driving roller. The discharge head 14 mounted on the carriage 6 is arranged opposed to the platen 12. The discharge head 14 is a printhead that discharges liquid ink to form an image. By discharging the ink from the discharge head 14 to the printing medium M conveyed onto the platen 12, the image is printed on the printing medium M. The printing medium M on which the image has been printed is wound up by the take-up unit 5. The printing medium M on which the image has been printed may be cut by a user with scissors or the like, or may be automatically cut by a cutter (not shown).

The maintenance unit 8 is arranged in the main body 3. The maintenance unit 8 is arranged outside a printing area of the discharge head 14 (outside a discharge area) and performs processes and the like relating to recovery and maintenance of the discharge performance of the discharge head 14. As such processes, for example, a pre-discharge process for discharging a predetermined amount of ink before and after the printing operation, and a process of suctioning residual ink and the like from the discharge port of the discharge head 14 may be enumerated. The discharge head 14, when such processes are required, is moved onto the maintenance unit 8 as shown in FIG. 1A.

In this embodiment, the stands 4 are arranged at positions each at slightly outside the width of the printing medium M in the X direction, in order to support, while supporting the main body 3, the high weight feeding unit 13 and the take-up unit 5 as well. The main body 3 has a part that extends, in one direction in the X direction, outward than the stand 4, and the maintenance unit 8 is arranged (built in) in this extended part. The main body 3 also has a part that extends, in the other direction in the X direction, outside the printing medium M, and a waste liquid cartridge 9 is provided below the extended part. A waste liquid (waste ink and the like) sucked by the maintenance unit 8 flows into the waste liquid cartridge 9 and is collected. The waste liquid cartridge 9 may be arranged in the vicinity of the maintenance unit 8. However, in this embodiment, by arranging the waste liquid cartridge 9 in an empty space below the end portion of the main body 3, an installation area of the liquid discharge apparatus 2 is reduced.

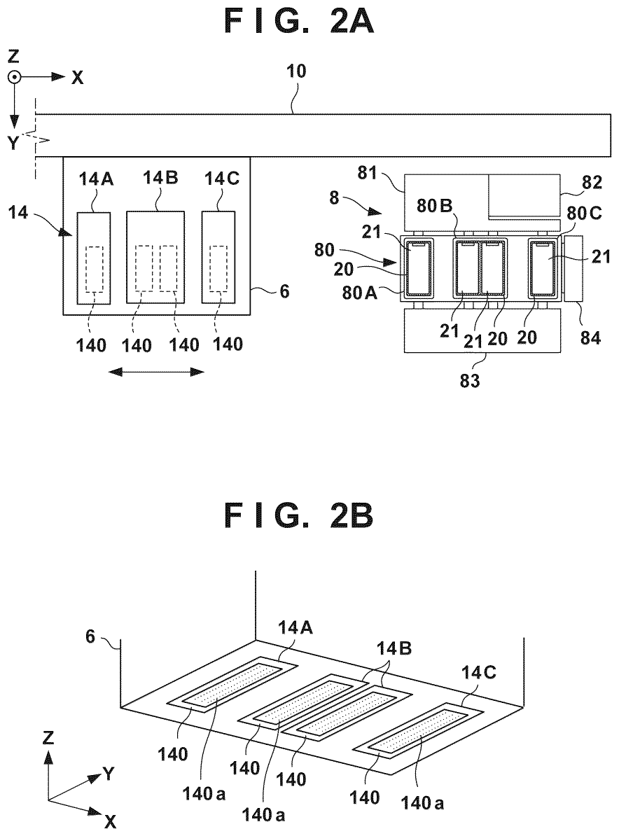

With reference to FIGS. 2A and 2B, structures related to the discharge head 14 and the maintenance unit 8 will be explained. FIG. 2A is a plan view of the interior of the main body 3 and, in particular, is an explanatory view of the carriage 6 and the maintenance unit 8. FIG. 2B is an explanatory view of discharge port surfaces 140 of the discharge head 14.

The discharge head 14 is mounted on the carriage 6. In this embodiment, three discharge heads 14A to 14C are mounted on the carriage 6 as the discharge head 14. The three discharge heads 14A to 14C are arrayed in the X direction. Each of the discharge heads 14A to 14C discharges a different type of ink. For example, the discharge head 14A discharges a reaction fluid. The discharge heads 14B and 14C discharge color material inks. The color material inks are, for example, nine types including black, cyan, yellow and magenta. In this case, for example, the discharge head 14B discharges six types of inks and the discharge head 14C discharges the remaining three types of inks, respectively.

Each of the discharge heads 14A to 14C has the discharge port surface 140 on the lower surface thereof. A plurality of discharge ports 140a for discharging the ink are formed on the discharge port surface 140. The discharge port 140a forms an array of discharge ports in the Y direction. Each discharge port 140a is provided with a discharge energy generating element such as an electrical-to-thermal conversion element (heater) or a piezoelectric element. When the electrical-thermal conversion element is used, the generated heat causes the ink to foam, and by utilizing its foaming energy, the ink can be discharged from the discharge port 140a.

The printing method of the present embodiment is the serial scan method. The carriage 6 is reciprocated in the X direction (a direction crossing the printing medium M) by a carriage movement unit 10. The carriage movement unit 10 is, for example, a belt transmission mechanism and includes a pair of pulleys spaced apart in the X direction, an endless belt wound around the pair of pulleys, a carriage motor that rotates one of the pulleys, and a guide member that guides movement of the carriage 6 in the X direction. The carriage 6 is fixed to the endless belt and moves by the running of the endless belt. Discharging the ink while moving the discharge head 14 in the X direction is called the printing scanning. By alternately repeating the conveyance of the printing medium M and the printing scanning of the discharge head 14, an image is printed on the printing medium M.

The maintenance unit 8 is provided with a capping device 80. The capping device 80 includes cap units 80A to 80C respectively corresponding to the discharge heads 14A to 14C. The cap units 80A to 80C are arrayed in the X direction in correspondence with the arrangement of the discharge heads 14A to 14C in the X direction. The capping device 80 is provided with an elevating unit 84 that raises and lowers the cap units 80A to 80C. The elevating unit 84 raises and lowers the cap units 80A to 80C in the Z direction between a capping position and a retreat position lower than the capping position. The capping position is a position where a cap 20, which will be described later, comes into contact with the discharge port surface 140 and covers the discharge port 140a, and the retreat position is a position where the cap 20 is spaced apart from the discharge port surface 140.

The maintenance unit 8 is also provided with a supply unit 81, a liquid tank 82, and a discharge unit 83. The supply unit 81 is a mechanism for supplying the liquid contained in the liquid tank 82 to the cap units 80A to 80C. The discharge unit 83 is a unit for suctioning and discharging the liquid from the cap units 80A to 80C.

### <Cap Unit>

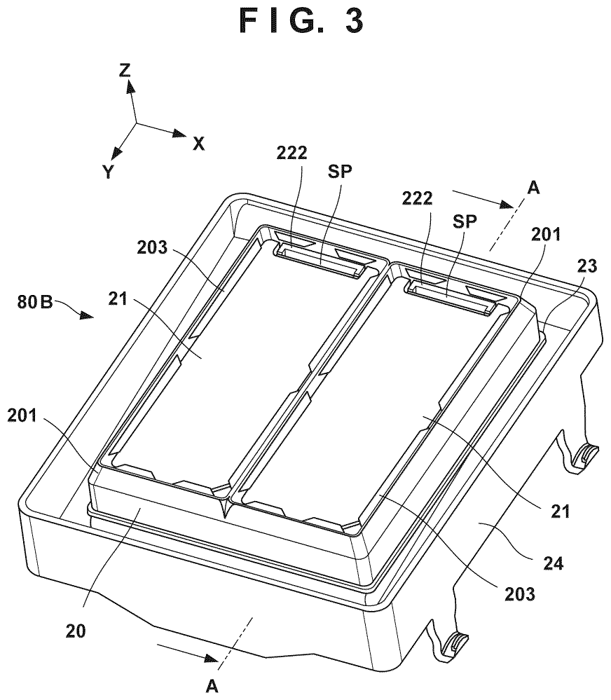

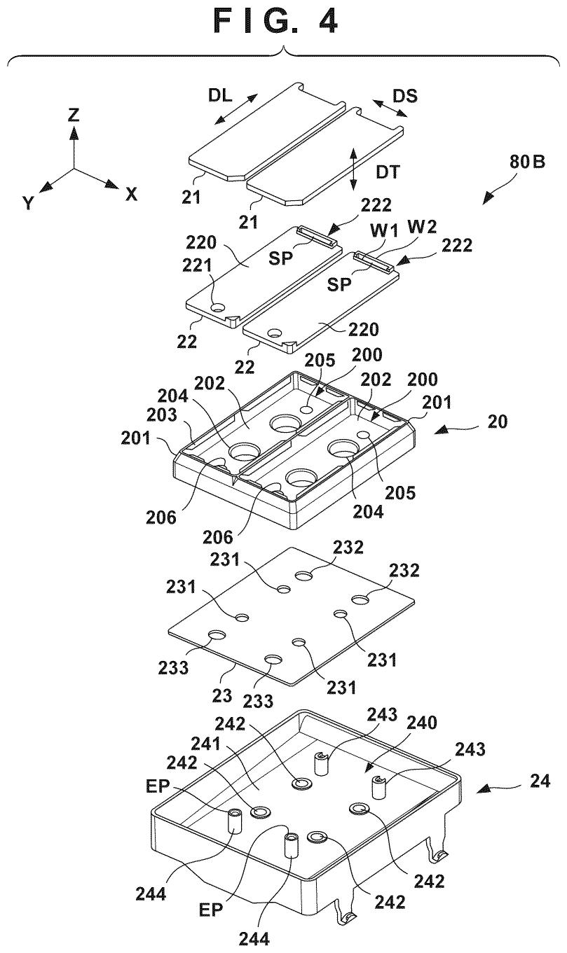

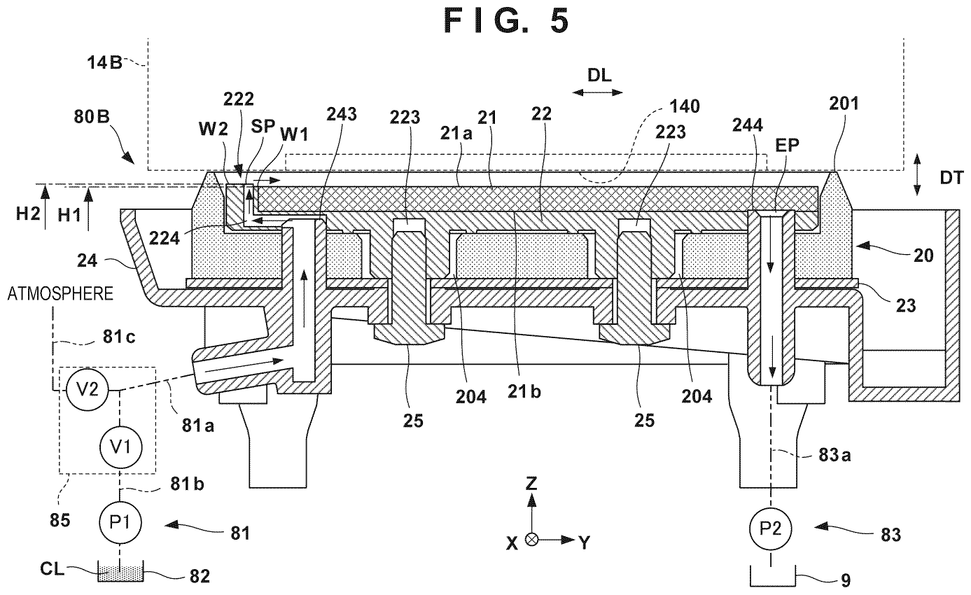

An explanation will be given as to the structure and the like of the cap unit 80B representing the cap units 80A to 80C. Note that the cap units 80A and 80C also have substantially the same structure. FIG. 3 is a perspective view of the cap unit 80B. FIG. 4 is an exploded perspective view of the cap unit 80B. FIG. 5 is a sectional view of the cap unit 80B taken along the line A-A in FIG. 3. In FIG. 5, the position of the discharge head 14B relative to the cap unit 80B located in the capping position is indicated by a short-dashed line.

The cap unit 80B is a laminated body of an absorbent member 21, a flow path forming member 22, the cap 20, a support plate 23, and a holder 24. The discharge head 14B has two discharge port surfaces 140 (FIG. 2B). Correspondingly, the cap unit 80B has two sets of the absorbent member 21 and the flow path forming member 22, and the cap 20 has two recess portions 200 that accommodate the absorbent member 21 and flow path forming member 22.

The absorbent member 21 is formed of a material (for example, a porous material) capable of absorbing the liquid. The absorbent member 21 is provided in the cap 20 so as to face the discharge port surface 140 at the time of capping. The absorbent member 21 of the present embodiment has a front surface (upper surface) 21a and a back surface (lower surface) 21b, and is a plate- or strip-shaped material having a rectangular shape as a whole, and the front surface 21a faces the discharge port surface 140. The arrows DL, DS and DT respectively indicate a longitudinal direction, a width direction and a thickness direction of the absorbent member 21. The absorbent member 21 has the rectangular shape that is long in the DL direction and short in the DS direction. In this embodiment, the longitudinal direction DL is the Y direction, the width direction DS is the X direction and the thickness direction DT is the Z direction.

The cap 20 is formed of an elastic material such as, for example, rubber, resin or the like. The cap 20 includes a recess portion 200 opening on a side (upper side) of the discharge port surface 140 and a peripheral wall of the recess portion 200 constitutes a lip portion 201. The lip portion 201 protrudes toward a side of the discharge port surface 140 than the front surface 21a of the absorbent member 21 in the DT direction. As the lip portion 201 comes into contact with the discharge port surface 140 at the time of capping, the inside of the recess portion 200 becomes a sealed space. On the inner peripheral wall of the recess portion 200, pressing pieces 203 are provided in plural places to prevent the absorbent member 21 from falling off. In the bottom 202 of the recess portion 200, mounting holes 204 and piping holes 205 and 206 are formed in such a manner as to penetrate the cap 20.

The holder 24 has a recess portion 240 opening on the side (upper side) of the discharge port surface 140, in which the absorbent member 21, the flow path forming member 22, the cap 20, and the support plate 23 are held. In the bottom 241 of the recess portion 240, mounting holes 242 corresponding to the mounting holes 204 are formed in such a manner as to penetrate the holder 24. Also in the bottom 241, cylindrical supply pipes 243 and discharge pipes 244 are formed. The support plate 23 is, for example, a metal plate and is a base plate for supporting the cap 20. In the support plate 23, mounting holes 231 corresponding to the mounting holes 204 and piping holes 232 and 233 through which the supply pipe 243 and the discharge pipe 244 pass through are formed.

The flow path forming member 22 includes a horizontal and flat placing surface 220 on which the absorbent member 21 is placed. The flow path forming member 22 also includes boss portions having screw holes 223 on the back side (lower surface of the flow path forming member 22) of the placing surface 220. By screwing screws 25 into the screw holes 223 through the mounting holes 242 of the holder 24, the mounting holes 231 of the support plate 23, and the mounting holes 204 of the cap 20, the flow path forming member 22, the cap 20, the support plate 23, and the holder 24 are integrally fixed.

At one end portion of the placing surface 220 in the Y direction, an outlet port 221 that penetrates the flow path forming member 22 is opened, and the discharge pipe 244 of the holder 24 reaches the back surface 21b of the absorbent member 21 through the piping hole 233 of the support plate 23, the piping hole 206 of the cap 20, and the outlet port 221 of the flow path forming member 22. The opening at the tip end of the discharge pipe 244 forms a liquid outlet port EP, and the peripheral edge of the outlet port EP (the tip end surface of the discharge pipe 244) is in contact with the back surface 21b of the absorbent member 21.

At the other end portion of the flow path forming member 22 in the Y direction, a supply port forming portion 222 is formed to protrude upwards from the placing surface 220. The supply port forming portion 222 forms a liquid supply port SP. The supply port forming portion 222 includes wall portions W1 and W2 spaced apart in the Y direction, and these wall portions W1 and W2 define the supply port SP. The wall portions W1 and W2 are extended in the X direction. Whereas the outlet port EP is a circular spot-shaped opening, the supply port SP is a slot-shaped opening extending in the X direction.

The flow path forming member 22 has a flow path 224 that communicates with the supply port SP, and the flow path 224 is opened to the back surface (the lower surface of the flow path forming member 22) of the placing surface 220. The supply pipe 243 of the holder 24 reaches the lower end portion opening of the flow path 224 through the piping holes 232 of the support plate 23 and the piping holes 205 of the cap 20, and the supply pipe 243 is communicated with the supply port SP via the flow path 224.

The supply unit 81 includes a pump P1 for pressure-feeding the liquid. In the liquid tank 82, in this embodiment, a cleaning liquid CL for cleaning the absorbent member 21 is contained. By driving the pump P1, the cleaning liquid CL is pressure-fed from the liquid tank 82 to the supply pipe 243 via pipes 81a and 81b. Accordingly, the cleaning liquid CL is supplied to the absorbent member 21 via the supply port SP.

The pipe 81a branches into the pipe 81b and a pipe 81c. The pipe 81c is an atmospheric communication portion open to the atmosphere. In the present embodiment, the supply port SP is used both as a supply port for the cleaning liquid CL and as a communication port for communicating the inside of the cap 20 to the atmosphere. Comparing to a configuration in which these are provided separately, the structure can be simplified. A switching unit 85 is a valve unit that switches the communication destination of the supply port SP between the pipe 81c communicated to the atmosphere and the pipe 81b communicated to the supply unit 81. In this embodiment, the switching unit 85 includes a supply valve V1 that opens and closes (communicates and blocks) the pipe 81b and an atmospheric communication valve V2 that opens and closes (communicates and blocks) the pipe 81c. By combining the opening and closing of the supply valve V1 and the atmospheric communication valve V2, the communication destination of the supply port SP can be switched.

The discharge unit 83 includes a pump P2 that pressure-feed the liquid. The pump P2 is communicated with the discharge pipe 244 via the pipe 83a. By driving the pump P2, it is possible to suck the liquid absorbed in the absorbent member 21 via the outlet port EP and pressure-feed it to the waste liquid cartridge 9. The liquid to be discharged is the ink or the cleaning liquid CL absorbed in the absorbent member 21. By driving the pump P2 at the time of capping, it is also possible to suck under negative pressure and discharge the ink remaining in the discharge head 14 through the absorbent member 21.

### <Cleaning of Absorbent Member>

An explanation will be given as to cleaning of the absorbent member 21 by the cleaning liquid CL. The absorbent member 21 is contaminated by the ink from the discharge head 14. Therefore, cleaning of the absorbent member 21 is required. In this embodiment, the absorbent member 21 can be cleaned by supplying the cleaning liquid CL from the supply port SP to the absorbent member 21 and by discharging the cleaning liquid CL absorbed in the absorbent member 21 from the outlet port EP. It is desirable that cleaning of the absorbent member 21 is carried out quickly from the view point of improving the productivity of the liquid discharge apparatus 2. In this embodiment, a structure is adopted by which permeation of the cleaning liquid CL into the absorbent member 21 can be done in a shorter time.

Referred to FIG. 5 mainly, in this embodiment, the supply port SP is formed at a position higher than the outlet port EP. More specifically, the outlet port EP is located at (in contact with) the back surface 21b of the absorbent member 21, whereas the supply port SP is located in the vicinity of the front surface 21a. By supplying the cleaning liquid CL to the absorbent member 21 from a higher position, permeation of the cleaning liquid CL into the absorbent member 21 can be done efficiently by the aid of gravity. Since the outlet port EP and the supply port SP are provided separately, switching from supply to discharge of the cleaning liquid CL can be performed quickly, or an operation in which a supply time and a discharge time of the cleaning liquid CL partially overlap can also be carried out.

Diffusion of the cleaning liquid CL to the absorbent member 21 is facilitated as the cleaning liquid CL flows, not inside the absorbent member 21, but on the front surface of the absorbent member 21. The flow of the cleaning liquid CL on the front surface 21a of the absorbent member 21 is facilitated by forming the supply port SP at a position where at least part of the liquid from the supply port SP flows directly onto the front surface 21a of the absorbent member 21, without passing through the inside of the absorbent member 21. The front surface 21a of the absorbent member 21 is a place where the ink received from the discharge head 14 is deposited, and by being supplied with the cleaning liquid CL and cleaned, the deposition of the ink can be reduced.

In this respect, in this embodiment, it is so designed that a height H1 of the wall portion W1 becomes the same with a height of the front surface 21a of the absorbent member 21. Therefore, the supply port SP is located at the same height as the front surface 21a in the thickness direction DT of the absorbent member21, and the liquid from the supply port SP flows on the front surface 21a of the absorbent member 21, without passing through the inside of the absorbent member 21. The cleaning liquid CL can be supplied quickly over the entire area of the absorbent member 21. Note that the supply port SP may be formed higher than the front surface 21a.

Further, the outlet port EP is at a position to be covered by the absorbent member 21, whereas the supply port SP is not covered by the absorbent member 21. In other words, in the plan view of the cap unit 80B (when viewed from above in the DT direction of the absorbent member 21), the supply port SP and the front surface 21a of the absorbent member 21 are exposed, hence the flow of the cleaning liquid CL along the front surface 21a is facilitated. On the other hand, by the action of gravity and discharge at the outlet port EP, it becomes easy for the cleaning liquid CL to flow downward inside the absorbent member 21. It is therefore possible to allow the cleaning liquid CL to permeate the entire area of the absorbent member 21.

In this embodiment, the height H1 in the Z direction of the wall portion W1 located on the side of the absorbent member 21 in the DL direction is lower than a height H2 of the wall portion W2 located on the opposite side. The cleaning liquid CL from the supply port SP is more easily directed towards the absorbent member 21, hence the cleaning liquid CL can be supplied to the absorbent member 21 even more quickly.

In this embodiment, the supply port SP and the outlet port EP are spaced apart in the DL direction, in particular, the outlet port EP is located at one end portion of the placing surface 220 in the DL direction and the supply port SP is located outside the absorbent member 21 on the side of the other end portion of the placing surface 220. In the middle region of the absorbent member 21 in the DL direction, not only supply of the cleaning liquid is improved by diffusion of the cleaning liquid CL from the supply port SP, but also the cleaning liquid is drawn toward the side of the outlet port EP by the discharge from the outlet port EP. Accordingly, cleaning of the entire absorbent member 21 can be performed efficiently. Furthermore, in this embodiment, the supply port SP has a slot shape extended in the DS direction. The cleaning liquid CL can easily permeate into the absorbent member 21 not only in the DL direction but also in the DS direction.

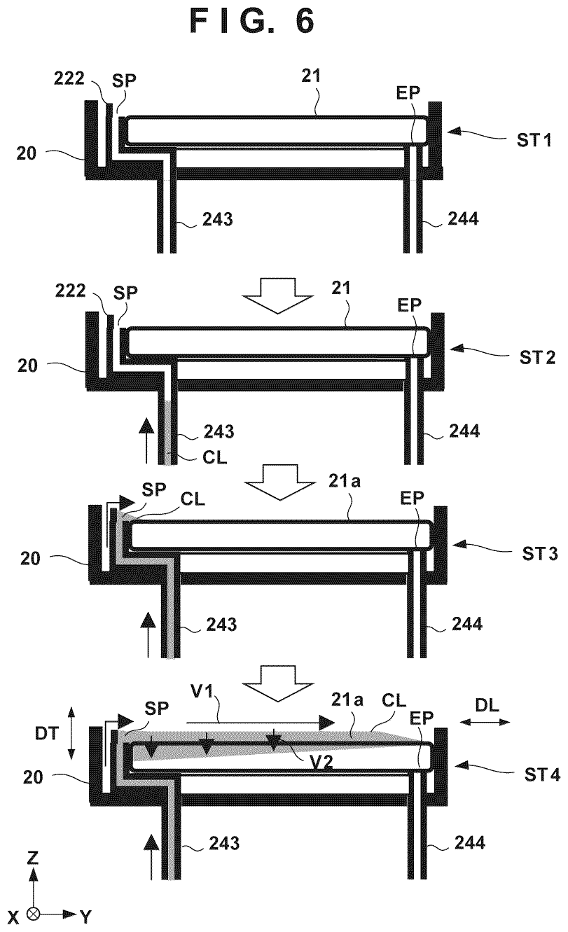

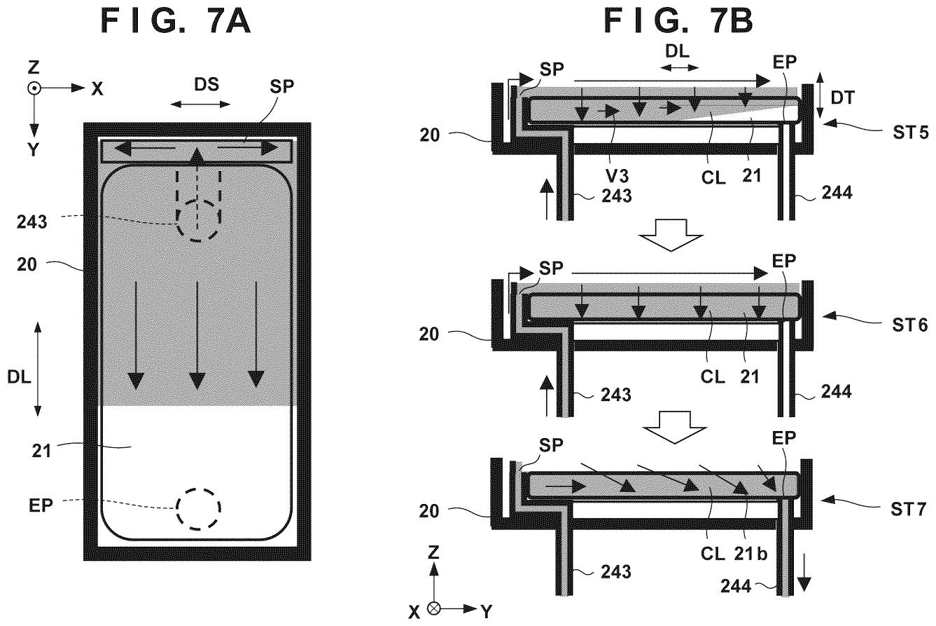

With reference to FIG. 6 and FIGS. 7A and 7B, an explanation will be given as to an example of cleaning action of the absorbent member 21. These figures are schematic views illustrating flow modes of the cleaning liquid CL at the time when cleaning the absorbent member 21.

The state ST1 in FIG. 6 shows a state before cleaning. When the pump P1 of the supply unit 81 is driven, as shown in the state ST2, the cleaning liquid CL is pressure-fed to the supply pipe 243. The pump P2 of the discharge unit 83 is stopped. After a while, as shown in the state ST3, the cleaning liquid CL begins to flow out from the supply port SP onto the absorbent member 21.

Since the interior of the absorbent member 21 has a flow resistance, a permeation velocity is slow, and a flow rate of the cleaning liquid CL flowing on the front surface 21a of the absorbent member 21 is high. For this reason, as shown in the state ST4, diffusion of the cleaning liquid CL in the DL direction is faster and the permeation of the cleaning liquid in the DT direction is relatively slow. A velocity V1 represents the flow rate of the cleaning liquid CL flowing in the DL direction on the front surface 21a, and a velocity V2 represents the permeation velocity of the cleaning liquid CL flowing in the DT direction in the interior of the absorbent member 21. These velocities are in a relationship of V1>V2. FIG. 7A is a plan view of the absorbent member 21. As described above, because the supply port SP is extended in the DS direction, the cleaning liquid CL flows not only in the DL direction but also in the DS direction.

As shown in the state ST5 in FIG. 7B, also in the interior of the absorbent member 21, the cleaning liquid CL permeates in the DL direction and in the DS direction. A velocity V3 represents the permeation velocity of the cleaning liquid CL in the DL direction or in the DS direction permeating in the interior of the absorbent member 21. Due to the action of gravity, the velocity V2 is faster than the velocity V3. These velocities are in a relationship of V1>V2>V3.

The state ST6 indicates that the absorbent member 21 is mostly filled with the cleaning liquid CL. Whether or not the absorbent member 21 is filled with the cleaning liquid CL can be determined, for example, by the supply time (drive time, rotation speed and the like of the pump P1) of the cleaning liquid CL. Thereafter, as shown in the state ST7, the pump P1 of the supply unit 81 is stopped and the pump P2 of the discharge unit 83 is driven. The cleaning liquid CL permeated in the absorbent member 21 is discharged via the outlet port EP and the discharge pipe 244. Completion of the discharge can be determined by the drive time or the rotation speed of the pump P2.

With the above, the cleaning of the absorbent member21 is completed. In the example of FIG. 7B, the pump P2 of the discharge unit 83 was driven in the state where the absorbent member 21 was mostly filled with the cleaning liquid CL. However, for example, the pump P2 may be driven at an intermediate stage (for example, at the state ST4, or at the state ST5), or the pump P2 of the discharge unit 83 may be driven simultaneously with the start of the drive of the pump P1 of the supply unit 81. That is, at least part of the supply period and the discharge period may overlap. Permeation of the cleaning liquid CL into the absorbent member 21 can be performed in a shorter time.

### <Control Unit>

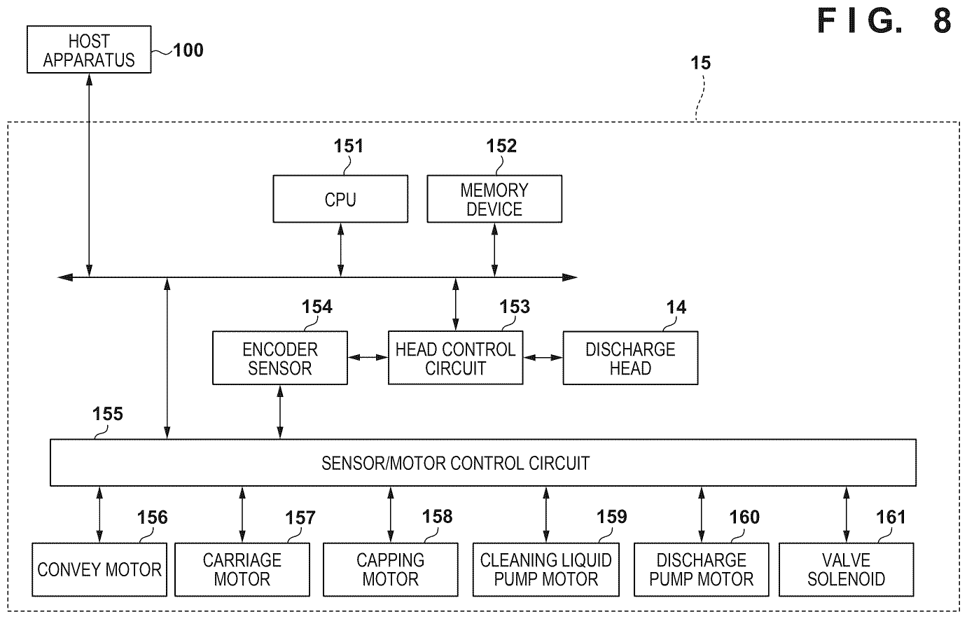

An explanation will be given as to a configuration of a control system of the liquid discharge apparatus 2. FIG. 8 is a block diagram of a control unit 15. The control unit 15 is a control circuit that controls the entire liquid discharge apparatus 2. The control unit 15 includes a CPU 151 which is a processor that controls the entire device, a memory device 152 such as a semiconductor memory and the like, and a sensor/motor control circuit 155 that controls each sensor and each motor. The CPU 151, the sensor/motor control circuit 155, and the memory device 152 are connected with each other so as to be able to communicate.

The memory device 152 stores programs to be executed by the CPU 151 and various information. The sensor/motor control circuit 155 controls a convey motor 156, a carriage motor 157, a capping motor 158, a cleaning liquid pump motor 159, a discharge pump motor 160, and a valve solenoid 161. The convey motor 156 is a drive source for the convey unit 11 and the carriage motor 157 is a drive source for the carriage movement unit 10. The capping motor 158 is a drive source for the elevating unit 84. The cleaning liquid pump motor 159 is a drive source for the pump P1 of the supply unit 81 and the discharge pump motor 160 is a drive source for the pump P2 of the discharge unit 83. The valve solenoid 161 is a drive source for the switching unit 85, and is the solenoid of each of the supply valve V1 and of the atmospheric communication valve V2.

The sensor/motor control circuit 155 controls, on the basis of a detection result of the encoder sensor 154 which detects a position of the carriage 6 in the X direction, the discharge of the ink from the discharge head 14 via the head control circuit 153.

Image data transmitted from the host apparatus 100 is converted into the discharge signal by the CPU 151, and the ink is discharged from the discharge head 14 according to the discharge signal and an operation of printing an image on the printing medium M00 is performed.

The CPU 151 includes, as its functional blocks, for example, a driver unit, a sequence control unit, an image processing unit, a timing control unit, and a head control unit. The sequence control unit controls overall printing control, more specifically, controls the starts and stops of the image processing unit, the timing control unit, and the head control unit, controls the conveyance of the printing medium, and controls the movement of the carriage 6, and the like. The control of each functional block is carried out such that the sequence control unit reads out various programs from the memory device 152 and executes the read-out programs. The driver unit generates, on the basis of commands from the sequence control unit, control signals to be sent to the sensor/motor control circuit 155, the memory device 152, the head control circuit 153, and the like, and also transmits an input signal from each block to the sequence control unit.

The image processing unit performs image processing in which the image data input from the host apparatus 100 is color-decomposed/converted and, by the discharge head 14, converted into printable printing data. The timing control unit transfers the printing data converted and generated by the image processing unit to the head control unit in conjunction with the position of the carriage 6. Further, the timing control unit also controls a signal which is for determining a discharge state of droplets and which is synchronized with discharge from each discharge port 140a. The head control unit converts the printing data input from the timing control unit into a discharge signal and outputs the converted signal. The head control circuit 153 generates a drive pulse in accordance with the discharge signal input from the head control unit and applies it to the discharge head 14.

### <Control Example>

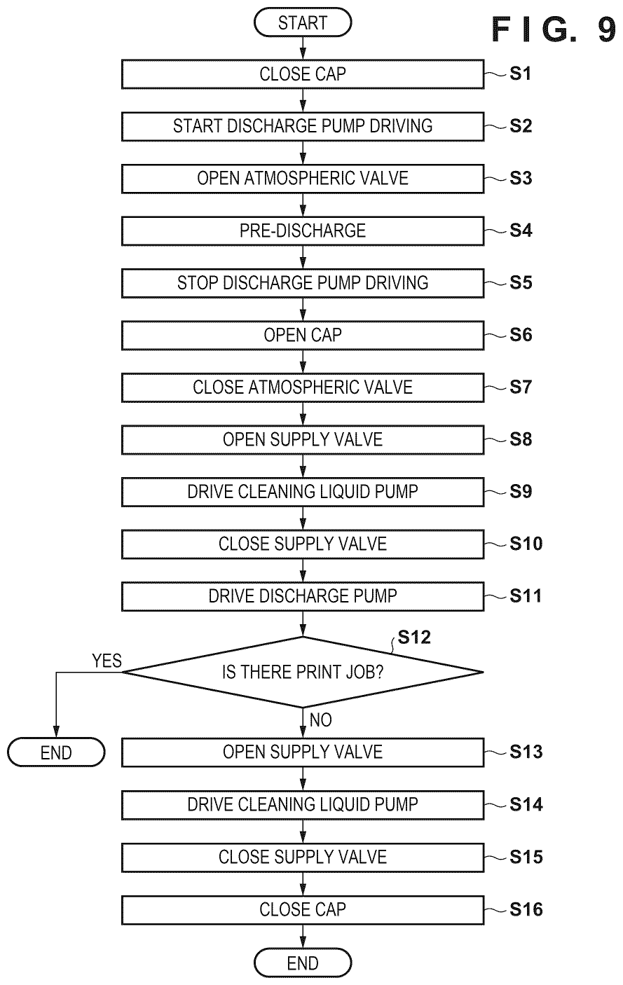

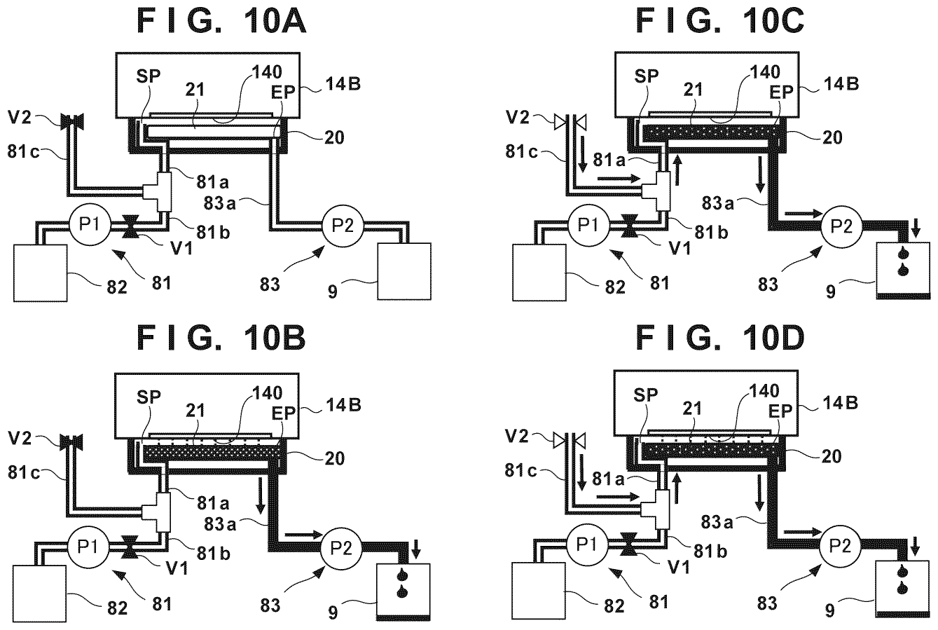

An explanation will be given as to an example of the control of the maintenance unit 8 by the control unit 15 with reference to FIGS. 9 to 12A. FIG. 9 is a flowchart illustrating a processing example of the control unit 15. FIGS. 10A to 12A are explanatory views illustrating operations of the maintenance unit 8.

As operations of the maintenance unit 8, a preservation operation, a cleaning operation, a discharge operation, and a pre-discharge operation can be enumerated.

The preservation operation is an operation for the purpose of maintaining the discharge performance of the discharge head 14 by controlling drying up of the discharge port surface 140 when the discharge head 14 is not in use, in which supply of the liquid to the absorbent member 21 and capping of the discharge port surface 140 by the cap 20 are performed. Here, the cleaning liquid CL is used as a liquid for preservation.

The cleaning operation is an operation for the purpose of cleaning the absorbent member 21, in which the cleaning liquid CL is supplied to the absorbent member 21 by the supply unit 81 to clean the absorbent member 21. The brief overview thereof has been explained with reference to FIGS. 5 to 7B.

The discharge operation is an operation for the purpose of recovering the performance of the discharge head 14, in which the liquid in the discharge head is discharged from the discharge port surface 140 via the absorbent member 21 by the discharge unit 83. The pre-discharge operation is an operation for the purpose of maintaining or recovering the performance of the discharge head 14 and is an operation to discharge the ink from the discharge head 14 to the absorbent member 21.

In this embodiment, these operations are performed using the common cap 20. If caps specialized for the respective purposes are provided separately, it causes increase in the size of the liquid discharge apparatus 2. In this embodiment, by performing these operations using the common cap 20, the size of the apparatus can be reduced.

The processing example in FIG. 9 is performed, for example, in a case where the ink discharge amount (dot count) of the discharge head 14 reaches a predetermined amount or in a case where a predetermined time has elapsed from the previous printing operation. Hereinafter, control of the discharge head 14B and the cap unit 80B will be explained as representative, however it is the same for other discharge heads and cap units.

In S1, cap closing is performed to the discharge head 14B. Here, after moving the discharge head 14B onto the cap unit 80B, the elevating unit 84 is driven to move the cap unit 80B to a capping position. The discharge port surface 140 of the discharge head 14B is capped by the cap 20 of the cap unit 80B. FIG. 10A shows a cap closed state. A lip portion 201 of the cap 20 comes into contact with the discharge port surface 140 and the discharge port 140a is airtightly covered by the cap 20. Drying up of the discharge port 140a is prevented. If the ink was adhered to the discharge port surface 140, the adhered ink is absorbed by the absorbent member 21 when the adhered ink comes into contact with the absorbent member 21. Different types of inks are prevented from mixing on the discharge port surface 140. Note that the supply valve V1 and the atmospheric communication valve V2 are in the closed state.

In S2 in FIG. 9, drive of the pump P2 of the discharge unit 83 is started. FIG. 10B shows this state. The interior of the cap 20 is suctioned via the outlet port EP. The ink is suctioned and discharged from the discharge port surface 140 of the discharge head 14B by the pump P2 via the absorbent member 21 (head nozzle suction). This head nozzle suction has an effect of discharging a thickened ink in the discharge port 140a.

In S3 in FIG. 9, the atmospheric communication valve V2 is switched to an open state. Accordingly, the interior of the cap 20 is made to be communicated with the atmosphere and idle suction is performed to suction the liquid in the interior of the cap 20 without suctioning the ink from the discharge head 14B. FIG. 10C shows this state. By taking in the air into the interior of the cap 20, outflow of the ink from the discharge head 14B is stopped and the ink in the interior of the cap 20 is discharged.

In S4 in FIG. 9, the ink is discharged from the discharge head 14B to the absorbent member 21 (idle suction and pre-discharge). FIG. 10D shows this state. By suctioning the interior of the cap 20 while performing the pre-discharge, the ink in the interior of the cap 20 can be discharged and mixing of different types of inks on the discharge port surface 140 can be suppressed. Note that the process of S4 may be omitted and may proceed to S5 after S3.

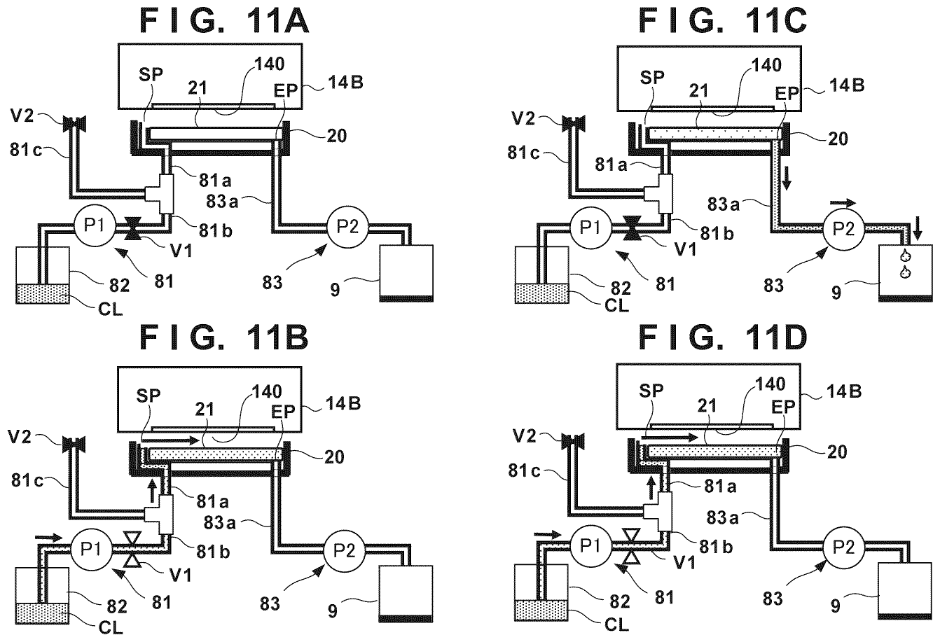

In S5 in FIG. 9, the pump P2 of the discharge unit 83 is stopped. In S6, cap opening for the discharge head 14B is performed. Here, the elevating unit 84 is driven to move the cap unit 80B to a retreat position. The cap 20 of the cap unit 80B is spaced apart from the discharge port surface 140 of the discharge head 14B. FIG. 11A shows the cap open state.

Next, the absorbent member 21 is cleaned. In S7 in FIG. 9, the atmospheric communication valve V2 is switched to the closed state and, in S8, the supply valve V1 is switched to the open state. In S9, the pump P1 of the supply unit 81 is driven for a predetermined time and stopped thereafter. By driving the pump P1, the cleaning liquid CL is supplied to the absorbent member 21. FIG. 11B shows this state. The interior of the cap 20 and the absorbent member 21 are filled with the cleaning liquid CL. At this time, as explained in FIGS. 5 to 7B, the cleaning liquid CL permeates the absorbent member 21 in a short period of time.

In S10 in FIG. 9, the supply valve V1 is switched to the closed state and, in S11, the pump P2 of the discharge unit 83 is driven. FIG. 11C shows this state. The cleaning liquid CL absorbed in the absorbent member 21 and the cleaning liquid in the interior of the cap 20 are discharged by the pump P2 via the outlet port EP. Cleaning of the absorbent member 21 and the cap 20 is completed.

Note that, by repeating the processes S8 to S11, it is also possible to further enhance a cleaning effect of the absorbent member 21. The cleaning operation may be performed with the cap closed and, in this case, the atmospheric communication valve V2 may be opened while discharging the cleaning liquid (idle suction+cleaning liquid discharge).

In S12 in FIG. 9, it is determined whether there is a printing job to be executed from now on. If there is a printing job, the control process of the maintenance unit 8 is finished and moves to the process of execution of the printing job. If there is no printing job, proceeds to S13. In S13 to S16, the preservation operation is performed.

In S13, the supply valve V1 is switched to the open state. In S14, the pump P1 of the supply unit 81 is driven for a predetermined time and stopped thereafter. FIG. 11D shows this state. The interior of the cap 20 and the absorbent member 21 are filled with the cleaning liquid CL as a moisturizing liquid. The supply amount of the cleaning liquid CL may be less compared to the time of cleaning.

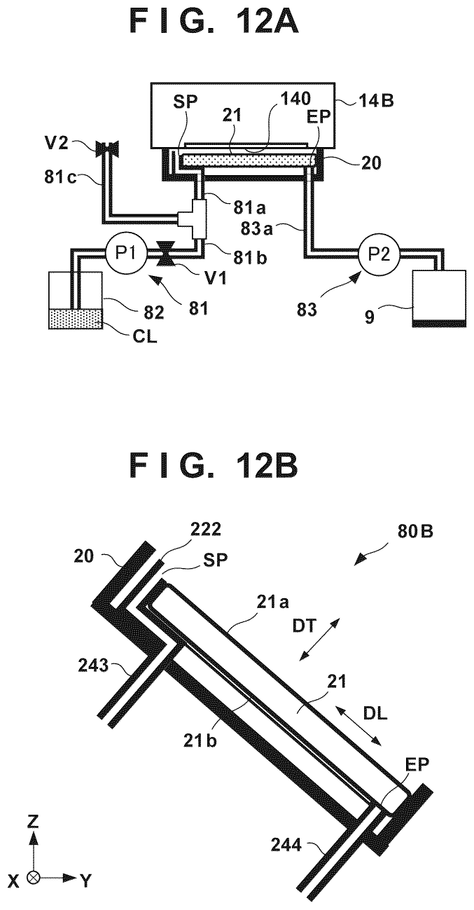

In S15 in FIG. 9, the supply valve V1 is switched to the closed state and, in S16, cap closing is performed for the discharge head 14B. Here, the elevating unit 84 is driven to move the cap unit 80B to the capping position. FIG. 12A shows this state. The discharge port surface 140 of the discharge head 14B is capped by the cap 20 of the cap unit 80B. The lip portion 201 of the cap 20 comes into contact with the discharge port surface 140 and the discharge port 140a is airtightly covered by the cap 20. Because the cleaning liquid CL is filled, as the moisturizing liquid, in the interior of the cap 20, the drying up of the discharge port surface 140 is suppressed and the discharge head 14B can be preserved. Note that the cap closing only may be performed without filling with the cleaning liquid CL as the moisturizing liquid (dry preservation).

### Second Embodiment

In a case where the discharge port surface 140 of the discharge head 14 is not horizontal but inclined, the cap units 80A to 80C may also be inclined correspondingly. FIG. 12B is a schematic view illustrating one example of the cap unit 80B.

The absorbent member 21 and the cap 20 are provided to be inclined so that the thickness direction DT of the absorbent member 21 has an angle to the Z direction. The supply port SP is provided on the side of the upper end portion of the absorbent member 21 and the outlet port EP is provided on the side of the lower end portion of the absorbent member 21. When the cleaning liquid CL flows out from the supply port SP, fluidity in the DL direction with respect to the absorbent member 21 increases due to action of the weight, hence the cleaning liquid CL can permeate more quickly into the absorbent member 21.

### Third Embodiment

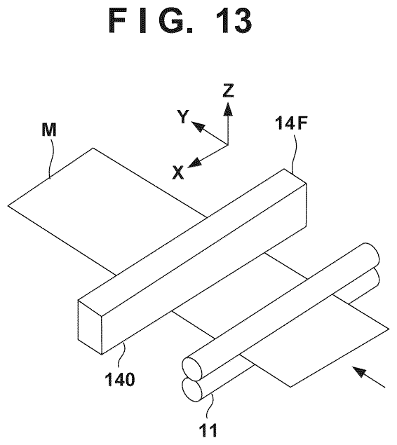

The above-described configuration of the cap unit is also applicable to a full-line type discharge head. FIG. 13 is a schematic view of the configuration of an apparatus using a full-line type discharge head 14F. The discharge port surface 140 of the discharge head 14F faces the printing medium M. In the discharge port surface 140, discharge ports are arrayed over a range covering the width of the printing medium M of a usable maximum size.

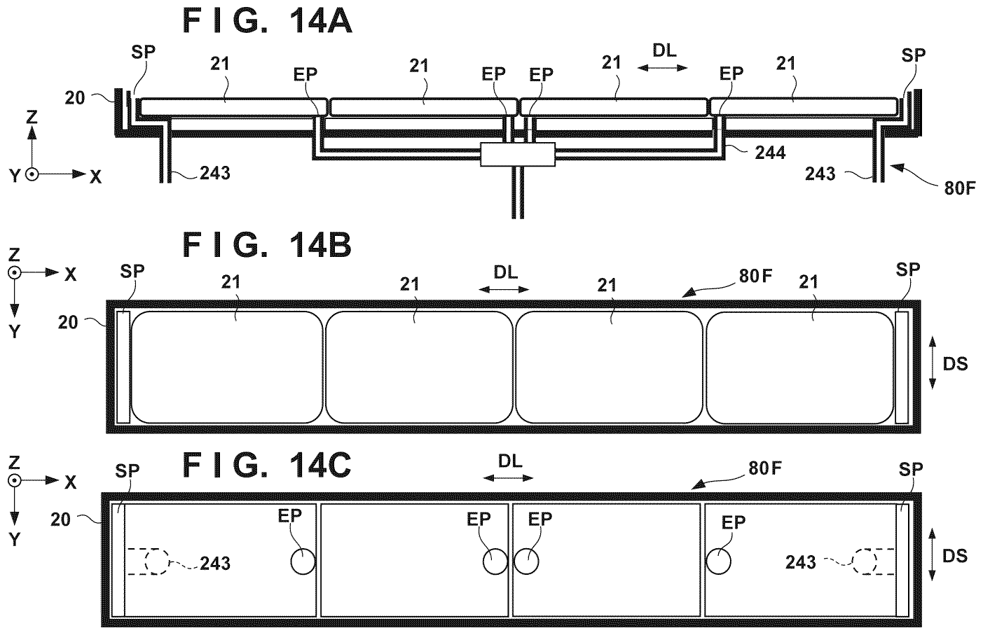

FIGS. 14A to 14C are schematic views of a cap unit 80F corresponding to the discharge head 14. FIG. 14A is a sectional view of the cap unit 80F, and FIG. 14B is a plan view. FIG. 14C is a plan view of the cap unit 80F with the absorbent members 21 removed.

The cap 20 has a size covering the entire area of the discharge port surface 140 of the discharge head 14F, and the absorbent member 21 is arranged in the interior of the cap 20. In the illustrated example, a plurality of the absorbent members 21 are arrayed in the X direction so that the absorbent members 21 correspond to the entire area of the discharge port surface 140. However, a single absorbent member 21 long in the X direction may be used.

The plurality of supply ports SP are provided. In this embodiment, two supply ports SP are provided to be spaced apart in the DL direction. One of the supply ports SP is located on the side of one end portion of the plurality of absorbent members 21 in the DL direction and the other of the supply ports SP is located on the side of the other end portion, respectively. The plurality of outlet ports EP are provided. In this embodiment, any of the outlet ports EP is arranged at a position between the two supply ports SP in the DL direction.

With this configuration, even though the absorbent members 21 are arranged over a wide area in the DL direction, it is possible to quickly supply and quickly discharge the cleaning liquid CL when cleaning the absorbent member 21. In either case, namely, in a case where the cap unit 80F is caused to be in a tilted posture or in a case where the cap unit 80F is installed in a tilted posture, because the supply ports SP are provided to be spaced apart at two locations in the DL direction, the supply of the cleaning liquid CL to the absorbent member 21 can be performed without delay.

### Fourth Embodiment

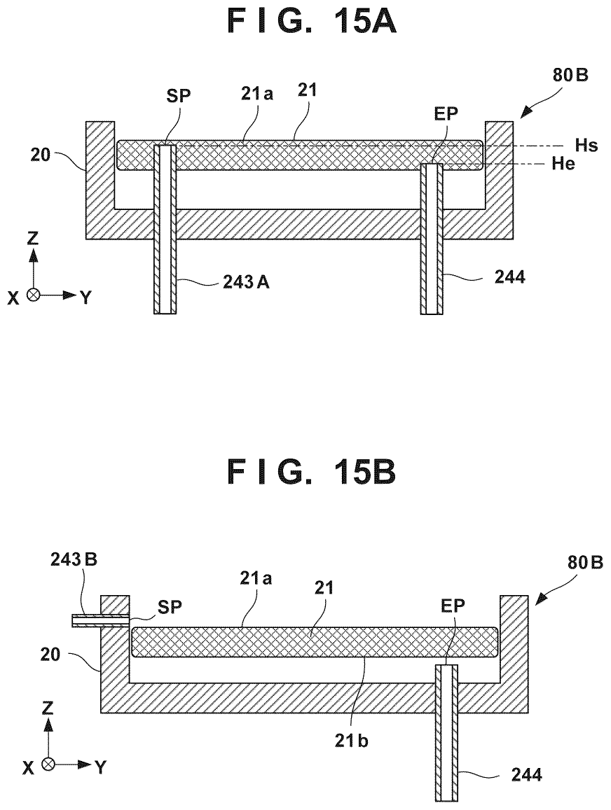

The position of the supply port SP is not limited to the positions in the above embodiments. FIGS. 15A and 15B illustrate another example of the supply port SP in the cap unit 80B. Of course, this is also applicable to the cap units 80A and 80C.

In the example of FIG. 15A, the supply port SP is provided at a tip end of a supply pipe 243A. The supply port SP is located in the absorbent member 21 and is at a position lower than the front surface 21a. In the plan view, the supply port SP is covered by the absorbent member 21. However, the height Hs of the supply port SP is higher than the height He of the outlet port EP. As the supply port SP is located close to the front surface 21a, the cleaning liquid flowing out from the supply port SP easily diffuses toward the downward direction of the absorbent member 21 by virtue of the action of gravity. On the other hand, the cleaning liquid easily wells up onto the front surface 21a and immediately flows on the front surface 21a and permeates over a wide area.

The example of FIG. 15B is an example in which the supply port SP is opened to a peripheral wall portion of the cap 20. A supply pipe 243B is arranged to penetrate the peripheral wall portion of the cap 20 and the supply port SP is located at a position higher than the front surface 21a of the absorbent member 21. Furthermore, in the example of FIG. 15B, the outlet port EP is spaced apart from the back surface 21b of the absorbent member 21. Such a configuration can also be adopted.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-179029, filed Oct. 17, 2023, which is hereby incorporated by reference herein in its entirety.

What is claimed is:

1. A liquid discharge apparatus comprising:
a cap configured to cap a discharge port surface of a discharge head that discharges a liquid;
an absorbent member provided in the cap so as to face the discharge port surface;
a supply unit configured to supply the liquid to the absorbent member via a supply port provided in the cap; and
a discharge unit configured to discharge the liquid absorbed in the absorbent member via an outlet port provided in the cap,
wherein the supply port is provided at a position higher than the outlet port, and
the supply port is provided at a position equal to or higher than a surface of the absorbent member in a thickness direction of the absorbent member.

2. The apparatus according to claim 1, wherein the supply port is formed at a position where at least part of the liquid from the supply port flows on the surface of the absorbent member.

3. The apparatus according to claim 1, wherein
the outlet port is provided at a position that is covered by the absorbent member, and
the supply port is provided at a position that is not covered by the absorbent member.

4. The apparatus according to claim 1, wherein, when the cap is viewed from above in a thickness direction of the absorbent member, the surface of the absorbent member and the supply port are exposed.

5. The apparatus according to claim 2, wherein assuming that
a speed at which the liquid from the supply port flows along the surface of the absorbent member is a first speed,
a speed at which the liquid from the supply port flows through the absorbent member in a thickness direction of the absorbent member is a second speed, and
a speed at which the liquid from the supply port flows through the absorbent member in a direction intersecting the thickness direction is a third speed,
the speeds are in a relationship of the first speed>the second speed>the third speed.

6. The apparatus according to claim 1, wherein the absorbent member is configured to be long in a first direction intersecting a thickness direction of the absorbent member, and be short in a second direction intersecting the thickness direction and the first direction, and
the supply port is provided outside the absorbent member in the first direction.

7. The apparatus according to claim 6, wherein the supply port is configured to be extended in the second direction.

8. The apparatus according to claim 6, wherein the apparatus includes
a first wall portion, which is configured to define the supply port, on a side of the absorbent member, and
a second wall portion, which is configured to define the supply port, facing the first wall portion, and
the first wall portion is configured to be lower than the second wall portion in the thickness direction of the absorbent member.

9. The apparatus according to claim 1, wherein the supply port and the outlet port are spaced apart from each other in a direction intersecting the thickness direction of the absorbent member.

10. The apparatus according to claim 1, wherein the absorbent member is configured to be long in a first direction intersecting a thickness direction of the absorbent member, and be short in a direction intersecting the thickness direction and the first direction, and
the supply port and the outlet port are spaced apart from each other in the first direction.

11. The apparatus according to claim 10, wherein
the absorbent member includes, in the first direction, a first end portion and a second end portion opposite the first end portion,
the supply port is provided on a side of the first end portion, and
the outlet port is provided on a side of the second end portion.

12. The apparatus according to claim 1, wherein a periphery of the outlet port is configured to be in contact with the absorbent member.

13. The apparatus according to claim 1, wherein
the cap includes a lip portion configured to be formed to enclose the absorbent member and is in contact with the discharge port surface, and
the lip portion is configured to protrude toward a side of the discharge port surface more than the surface of the absorbent member in the thickness direction of the absorbent member.

14. The apparatus according to claim 1, wherein
a first supply port and a second supply port are provided as the supply port,
the absorbent member is configured to be long in a first direction intersecting a thickness direction of the absorbent member, and be short in a direction intersecting the thickness direction and the first direction,
the absorbent member includes, in the first direction, a first end portion and a second end portion opposite the first end portion,
the first supply port is provided on a side of the first end portion, and the second supply port is provided on a side of the second end portion.

15. The apparatus according to claim 14, wherein
a plurality of outlet ports are provided as the outlet port, and
the plurality of outlet ports are provided, in the first direction, between the first supply port and the second supply port.

16. The apparatus according to claim 1, wherein
the absorbent member and the cap are inclinedly provided so that the thickness direction of the absorbent member has an angle relative to a vertical direction, and
the supply port is provided on a side of an upper end portion of the absorbent member.

17. The apparatus according to claim 1, wherein the apparatus comprises a control unit configured to control:
a preservation operation for performing supply of the liquid to the absorbent member by the supply unit, and capping of the discharge port surface by the cap;
a cleaning operation for cleaning the absorbent member using, as a cleaning liquid, the liquid from the supply port; and
a discharging operation for discharging the liquid in the discharge head from the discharge port surface via the absorbent member.

18. The apparatus according to claim 17, wherein the control unit further controls a pre-discharge operation for discharging the liquid from the discharge head to the absorbent member.

19. The apparatus according to claim 1, wherein the apparatus comprises a switching unit configured to switch a communication destination of the supply port between a pipe communicated to atmosphere and a pipe communicated to the supply unit.

20. The apparatus according to claim 1, wherein the discharge head is a printing head that discharges ink to a printing medium, and
the liquid discharge apparatus is a printing apparatus for printing an image onto the printing medium.
